(19) United States
(12) Patent Application Publication
(10) Pub. No.: US 2018/0261122 A1
(43) Pub. Date: Sep. 13, 2018

(54) Chinese Stroke Toys

(71) Applicant: Jingjuan Yu, NYC, NY (US)

(72) Inventor: Jingjuan Yu, NYC, NY (US)

(21) Appl. No.: 15/693,525

(22) Filed: Sep. 1, 2017

Related U.S. Application Data
(60) Provisional application No. 62/470,537, filed on Mar. 13, 2017.

(51) Int. Cl. G09B 17/00; G09B 19/06; G09B 1/00; A63H 33/06

(52) U.S. Cl. CPC G09B 17/00; A63H 33/06; G09B 1/00; G09B 19/06

(57) ABSTRACT

Herein I provide different methods for learning Chinese characters. Traditionally, children have learned Chinese characters through the repeated reading and copying of words from generic word-cards. This process is tedious and therefore often fails to retain the learner's attention. My method of learning Chinese characters, by contrast, is fun and engaging, combining both motor and cognitive skills. I have designed a cube with each side having one stroke, which children can grasp and play with. According to national standards, there are a total of 30 Chinese strokes. I have divided these into five cubes of six strokes each, as follows: Basic Strokes, Developed Strokes (A), Developed Strokes (B), Advanced Strokes (A), and Advanced Strokes (B). Parents (or other caregivers) and teachers are encouraged to interact with and observe children play with cubes. In addition, they can use my magnetic strokes to create their own Chinese characters.

### BRIEF BACKGROUND OF INVENTION

Traditionally, a native Chinese child starts to learn Chinese characters from 3-5 years old or at an elementary school; while non-native Chinese children begin to learn Chinese characters at the age of around 5. However, over the past decade, scientists (neurologists and physiologists in particular) have looked at the possibilities of infantile bilingual learning, from as early as two months old, thereby creating the need for appropriate educational tools.

The traditional method of teaching Chinese characters is very tedious: Teachers have kids read Chinese characters off of word cards and then copy them on paper, ad infinitum, resulting in children feeling bored and uninvolved. This invention, by contrast, includes effective toys and therefore fun and engaging. Parents (and other caregivers) or teachers encourage their pupils to play with the Chinese-stroke cubes and to create characters by themselves with magnetic strokes, thus stimulating the development of the hand movements linked to the brain.

### Theoretical Basis

Researches of modern brain science and Chinese meridian theory have shown that hand movement and the brain are intimately connected. A newborn baby of two months can grasp soft objects such as a stuffed cube; and at four months, the baby can pick up hard cubes. Thus, the child develops his or her motor skills as well as the brain circuitry needed to coordinate the movement of the fingers.

### Creating Chinese Characters

Learning Chinese presents a special challenge for a small child, especially one born in the West. On the other hand, Chinese characters are pictographs and, of course, children the world over love pictures. Indeed, by the age of two, children have the potential to perceive and draw color pictures. Using magnetic strokes, children can create their own Chinese characters and then proudly display strokes on a refrigerator or magnetic board; for examples: one héng [symbol] (one in English), two héng [symbol] (two in English), three héng [symbol] (three in English); or one heng and one shù [symbol] (ten in English); thereby significantly increasing the interest and motivation to memorize them. In this way, a child can quickly build a vocabulary that exceeds the core vocabulary of 120 words and phrases. (Please see related books, edited by the inventor).

### BRIEF SUMMARY OF INVENTION

The purpose of this invention is to present Chinese strokes to children in a natural and fun way, to stimulate their interest in learning Chinese characters, since non-native Chinese Americans grumble how difficult it is to learn to speak, read and write in Chinese.

It is said 800 Chinese characters are not only used in China but also in Japan, Korea, Singapore and other Asian countries for an elementary school. Traditionally, teachers have kids read words from cards and copy them numerous times on paper. To copy a word many times is tedious for young children; they feel bored and easily lose interest. This invention provides Chinese Strokes Toys to stimulate children to learn Chinese characters, through the movements of fingers and hands (closely linked to the brain) to reduce the time and burden of memorization and increase the efficiency of learning new words.

Theoretically, a baby's senses of touch, vision, and movement are vital for his brain development. As mentioned in the Claims section, this invention is for children and teachers to learn Chinese Characters, via playing with Chinese-stroke cubes and using magnetic pieces to make words, which are then engraved in children's memories.

### BRIEF DESCRIPTION OF THE DRAWINGS

FIG. 1 The standard Chinese strokes: the smallest unit of Chinese characters;

FIG. 2 Diagram of a cube with each side being 2 inches for the age of over two, using foam, or wood, plastic or other material;

FIG. 3 Diagram of a cube with each site being 1.5 inches for the age of 0-2,

using foam inside and cloth outside;

FIG. 4 The first cube of six Basic Chinese Strokes: héng, shù, di\check{a}n, piě, nà, and tí, with one stroke on each side;

FIG. 5 The second cube of six Developed Chinese Strokes (A): héng gōu, shù gōu, héng piě, héng zhé, shù zhé, and shù tí, with one stroke on each side;

FIG. 6 The third cube of six Developed Chinese Strokes (B) with one stroke on each side: héng zhé gōu, héng zhé tí, piě zhé, shù wān, shù wān gōu and piě di\check{a}n;

FIG. 7 The fourth cube of six Expanded Chinese Strokes (A) with one stroke on each side: xié gōu, wò gōu, wān gōu, héng xié gōu, héng zhé wān gōu and shù zhé zhé gōu;

FIG. 8 The fifth cube of six Expanded Chinese Strokes (B) with one stroke on each side: héng piě wān gōu, héng zhé zhé zhé gōu, héng zhé wān, héng zhé zhé zhé piě, shù zhé piě and shù zhé zhé;

FIG. 9 Magnetic pieces of Chinese Strokes, for use by children two years and up, to form their own words.

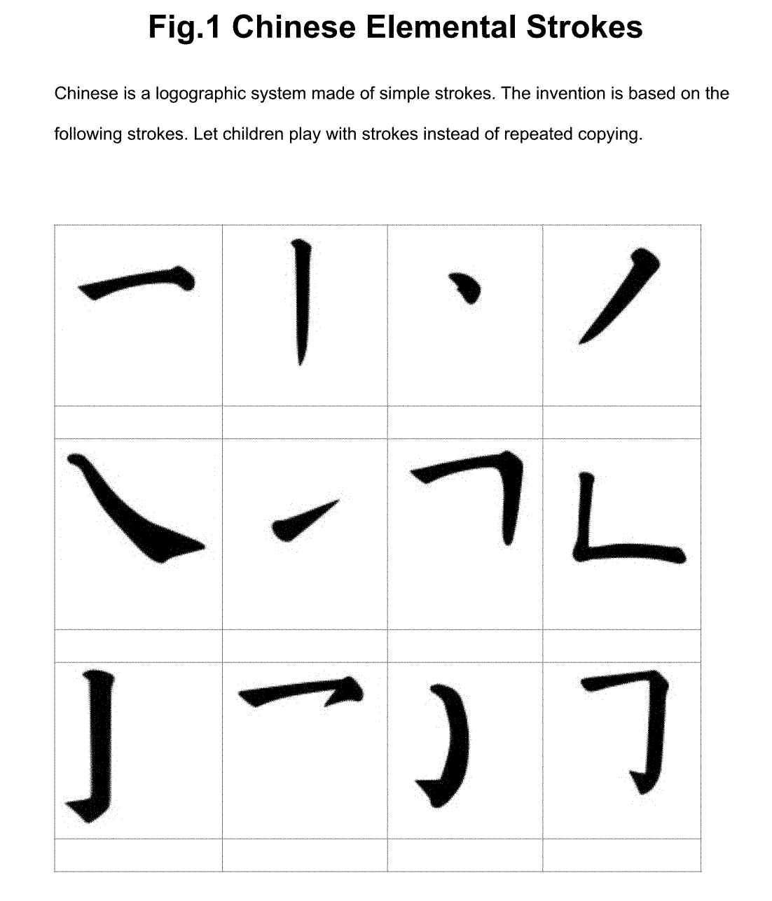

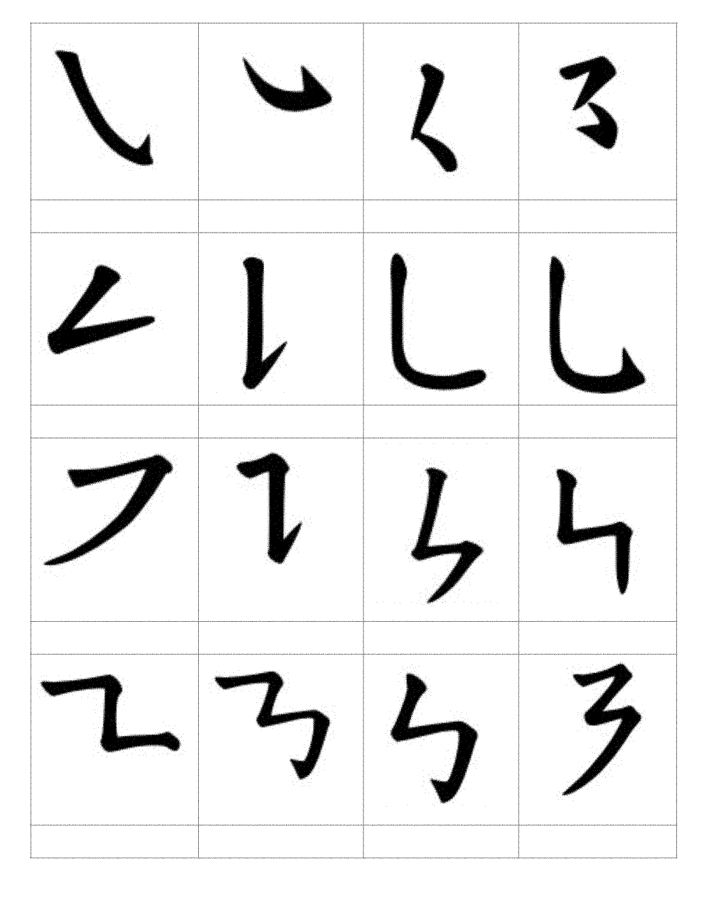

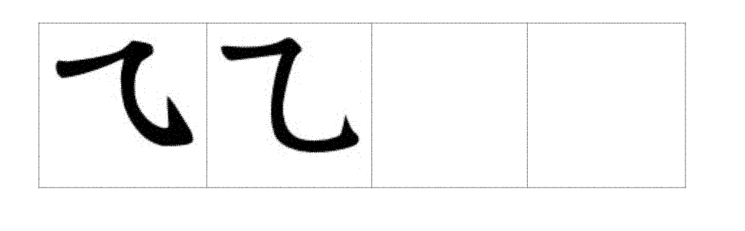

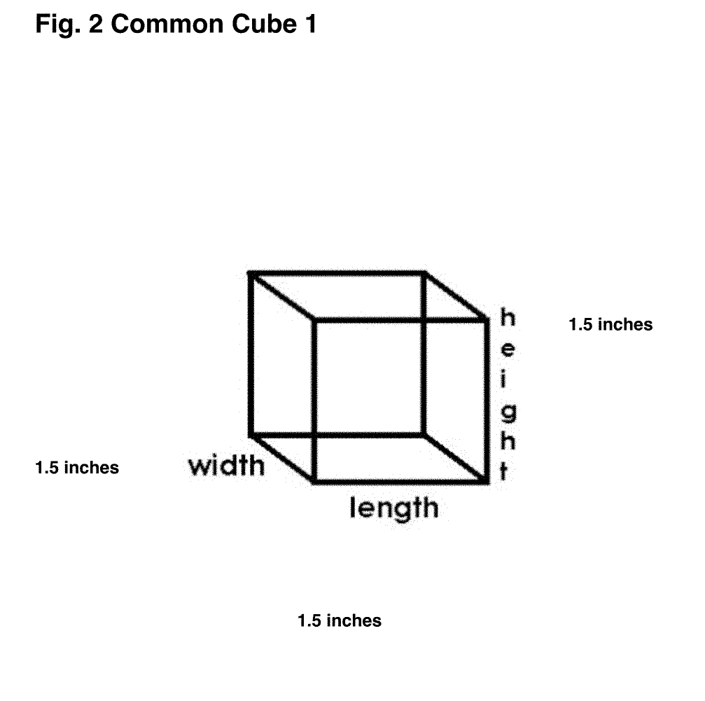

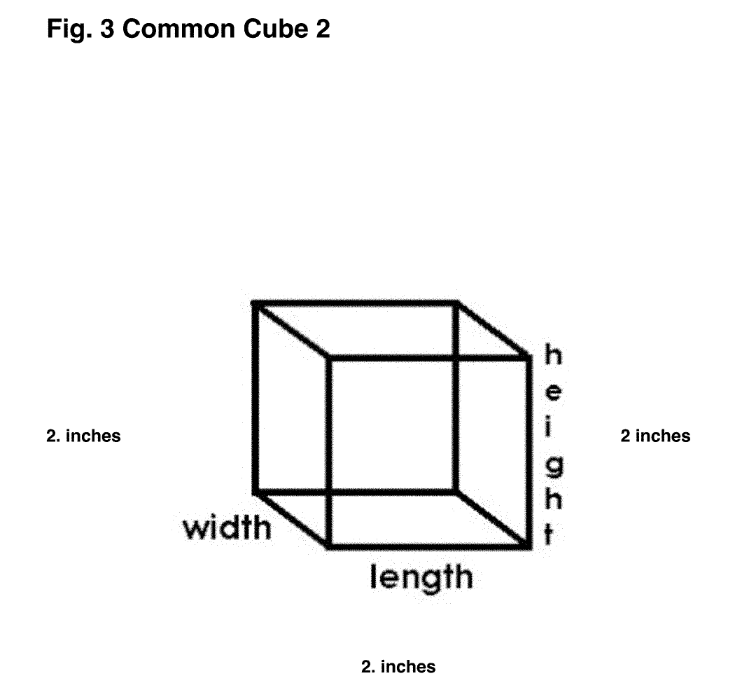

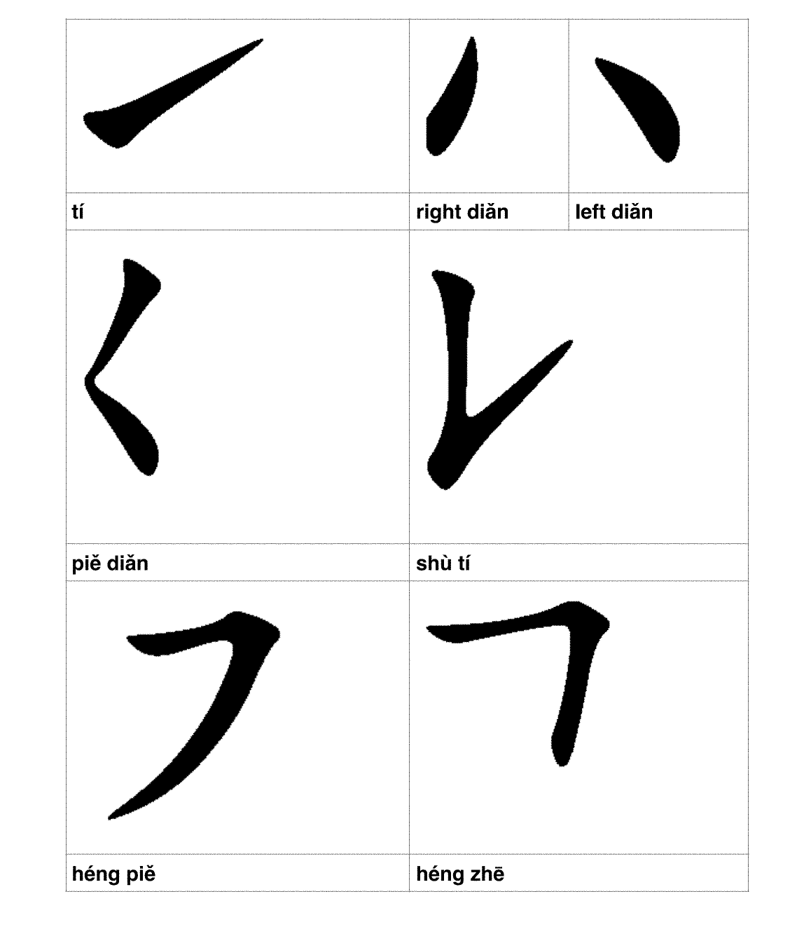

### DETAILED DESCRIPTION OF INVENTION

### Embodiment 1

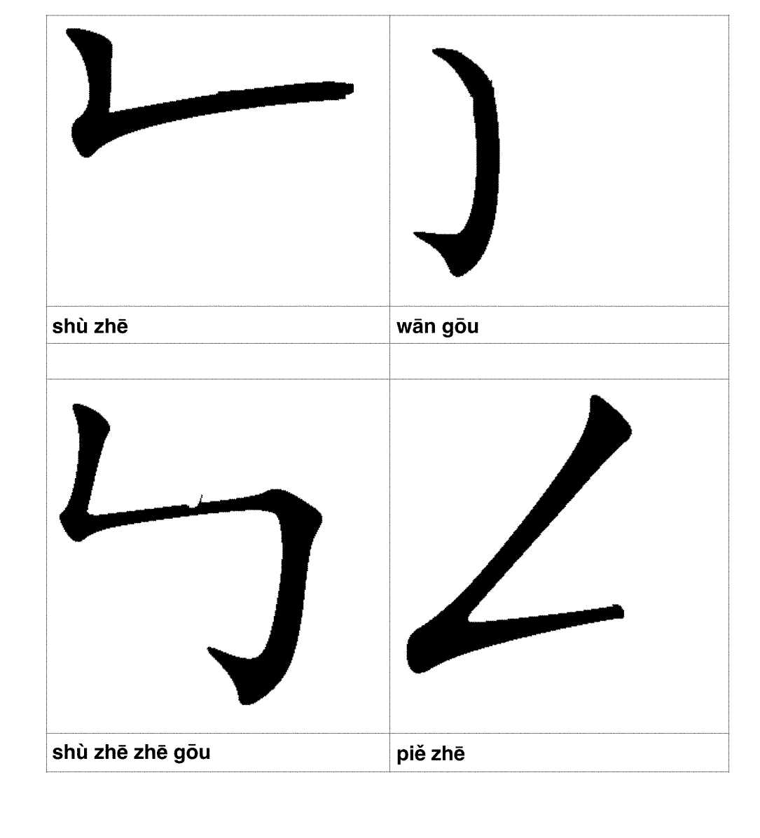

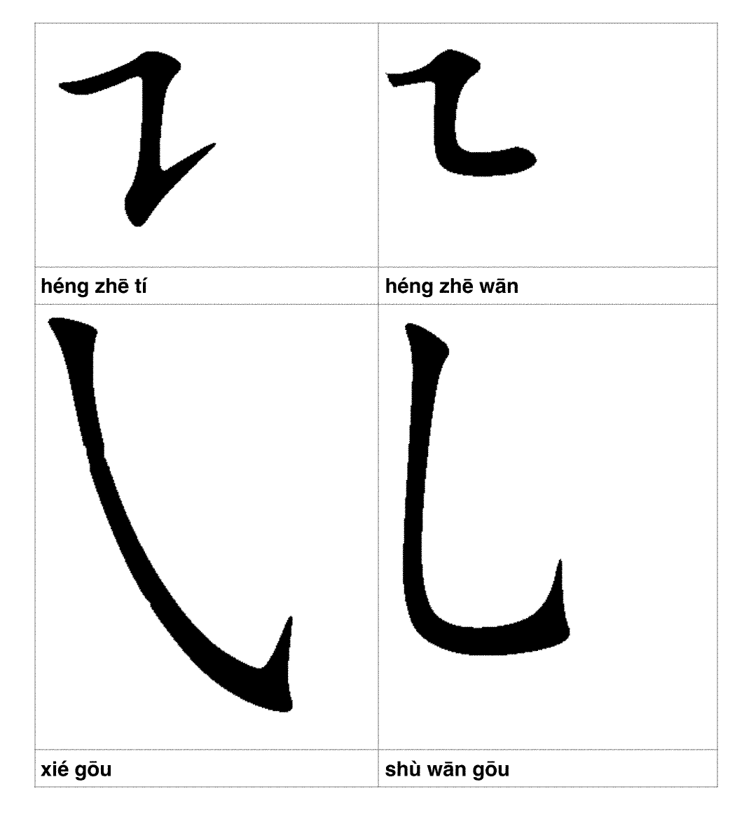

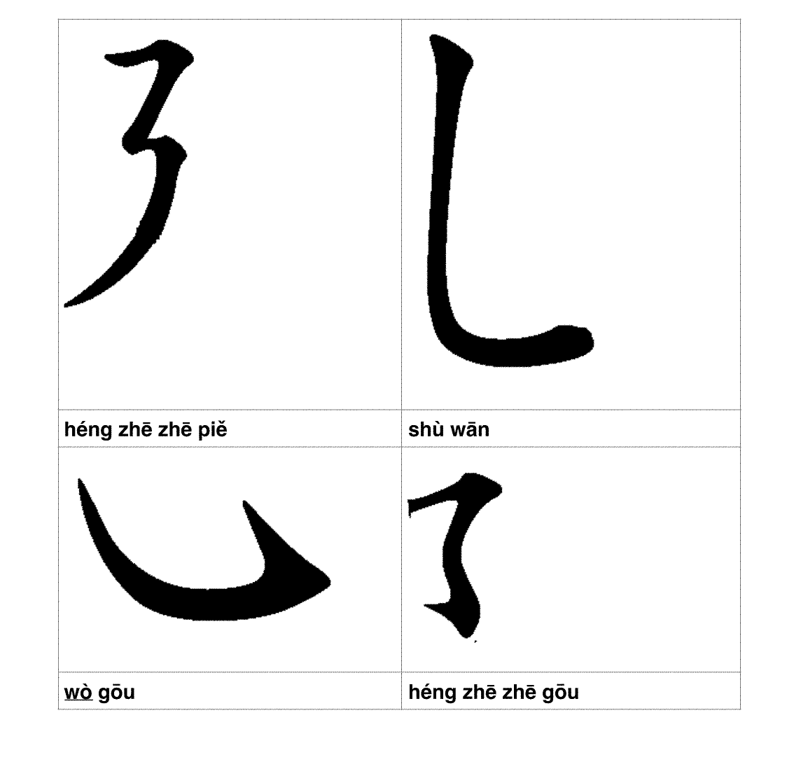

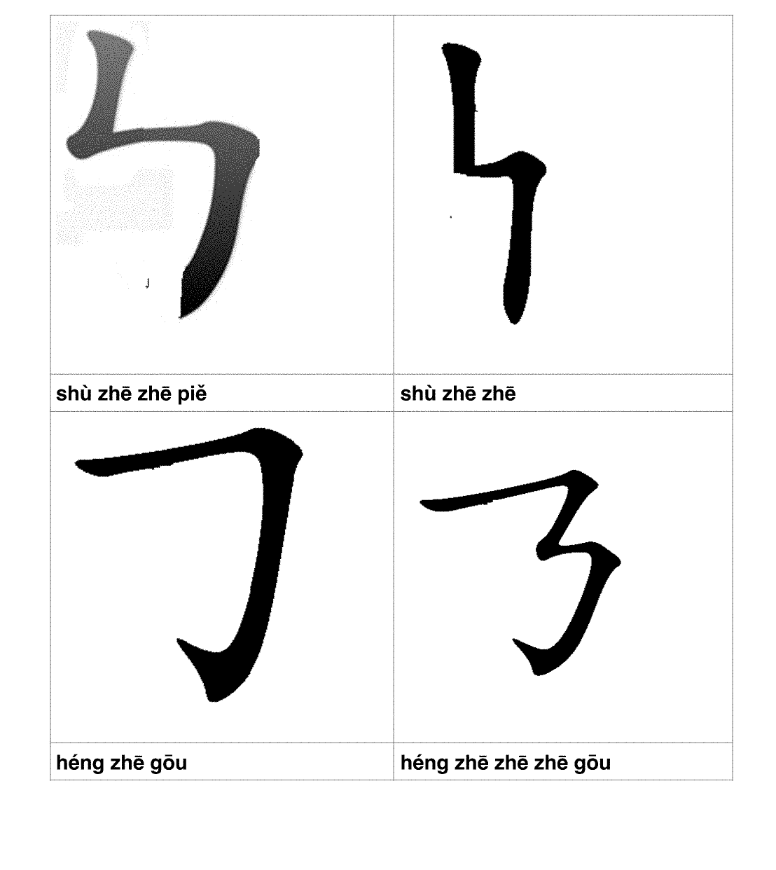

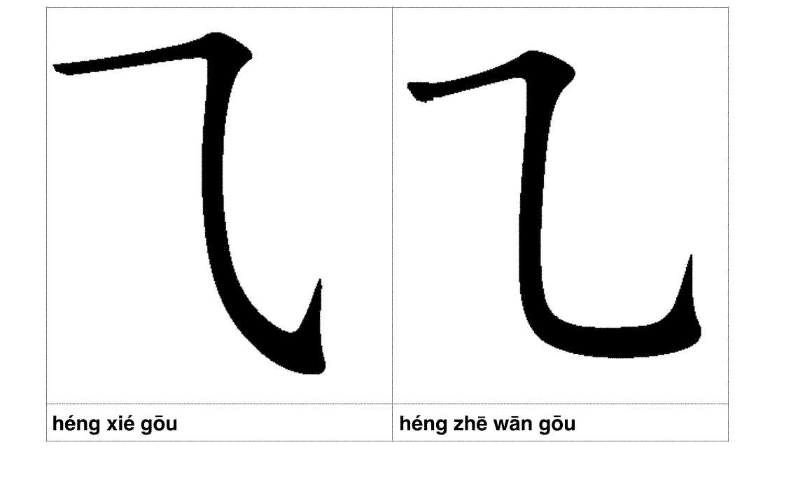

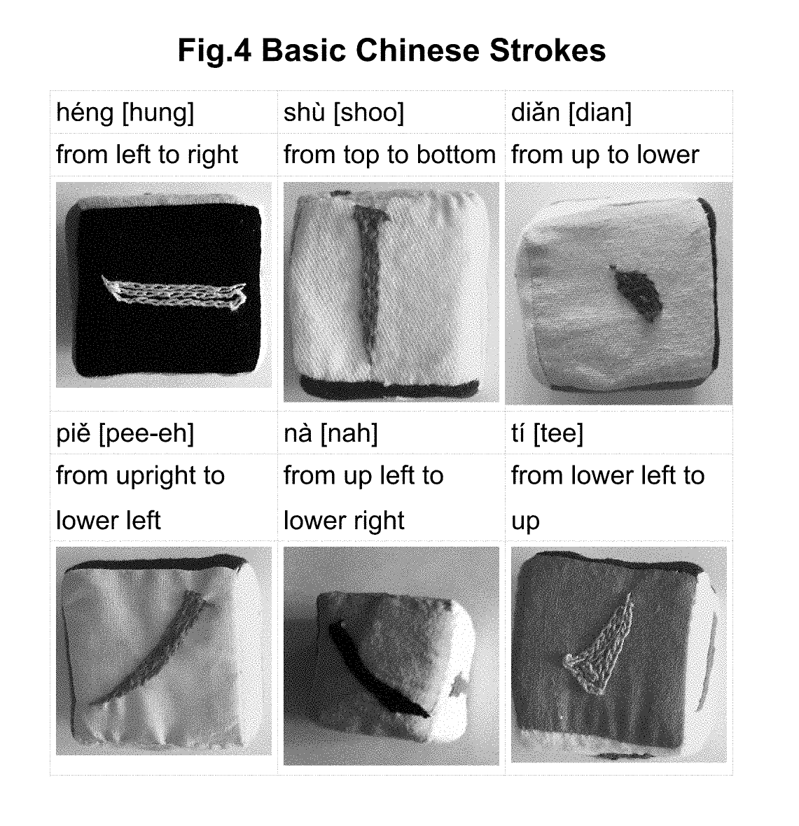

Referring to FIG. 4 the first cube of six basic Chinese Strokes which are the fundamental components of Chinese characters based on Chinese handwriting style, mommy (or a caregiver or a teacher) holds baby's finger moving in the direction of each stroke on the cube. In this way, mom (or a caregiver or a teacher) practices 1-10 minutes for three months. The length of time or period depends on the child's interest, as each child is unique.

Mommy (or a caregiver or a teacher or even the child if he can) rolls or throws up the cube then let the child moves along the direction of each stroke on the cube. In this way, mommy with her baby practices 5-10 minutes for three months. The length of time or period depends on the child's interest, as each child is individual.

### Embodiment 2

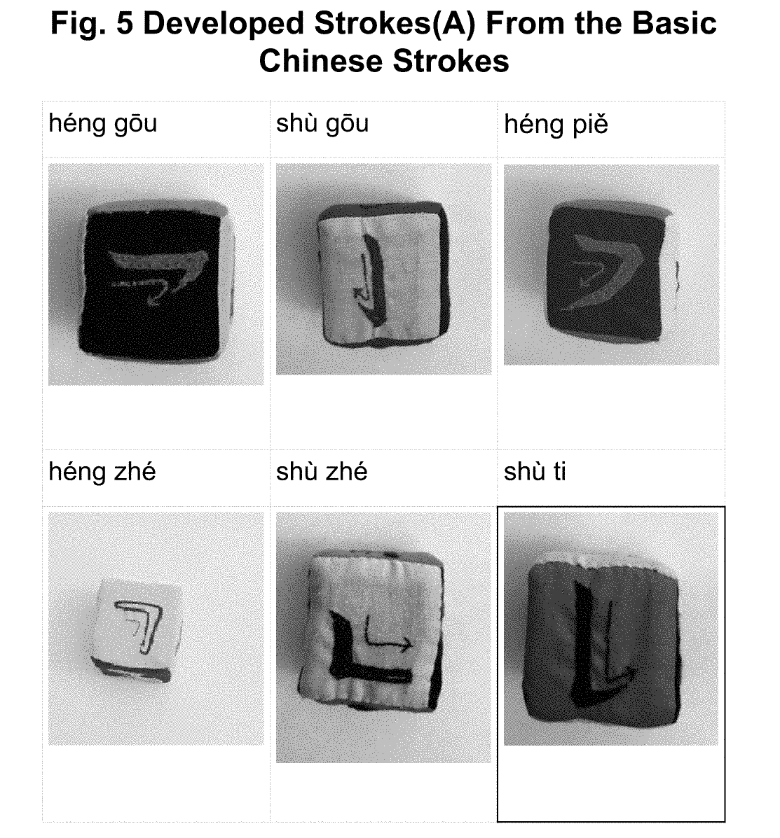

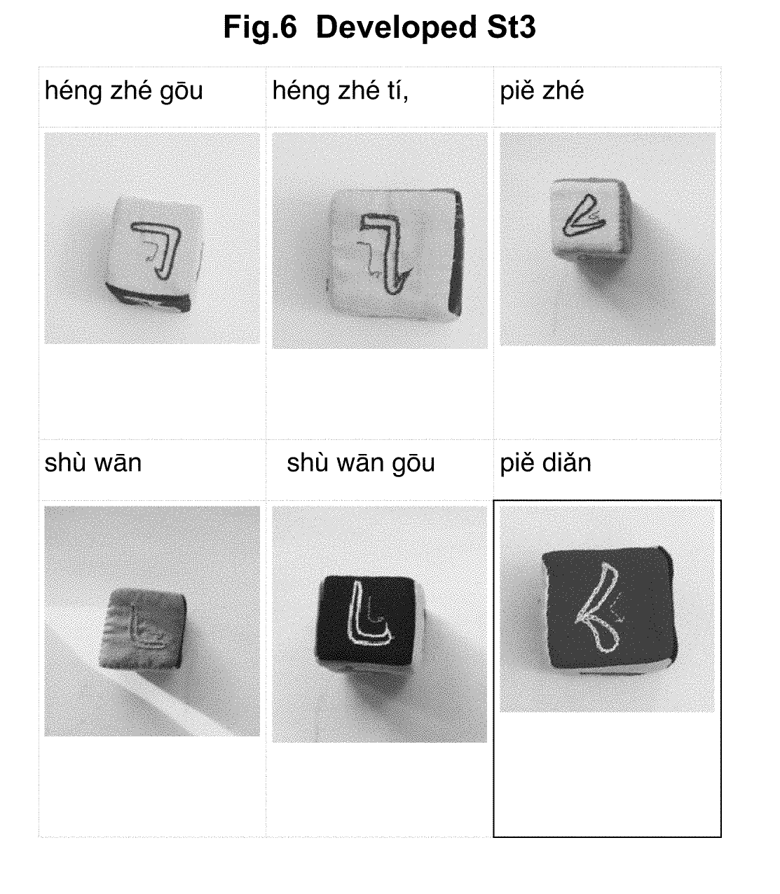

As shown in FIGS. 5 and 6, these strokes are developed from the first six Basic Chinese strokes. Using the same method as stated in EMBODIMENT 1. The length of time or period varies with baby's attention.

### Embodiment 3

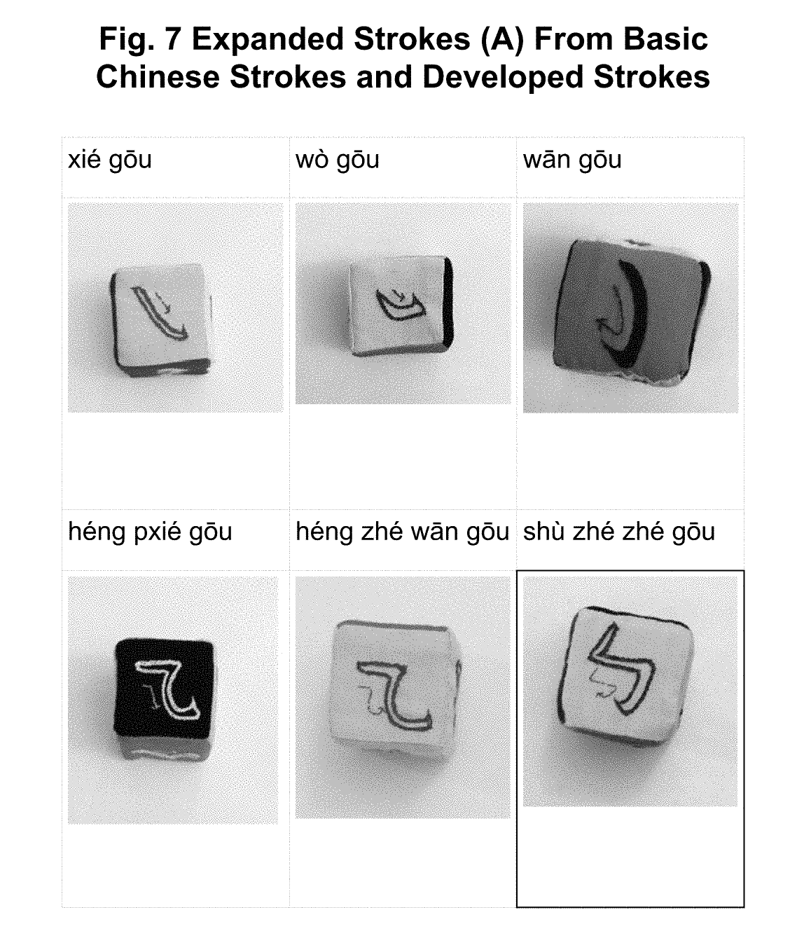

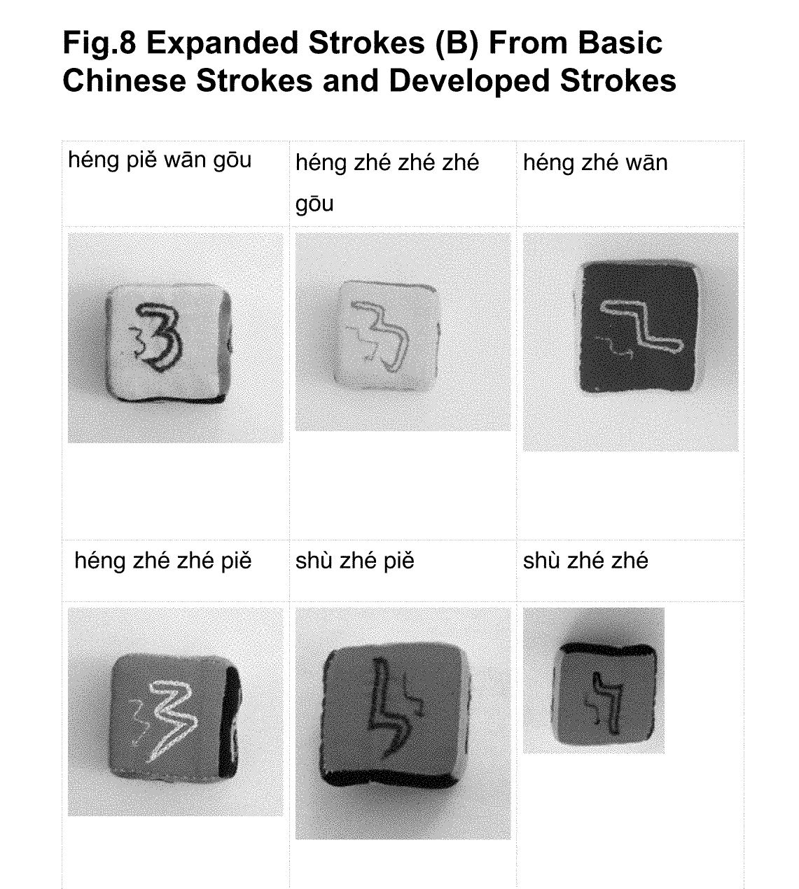

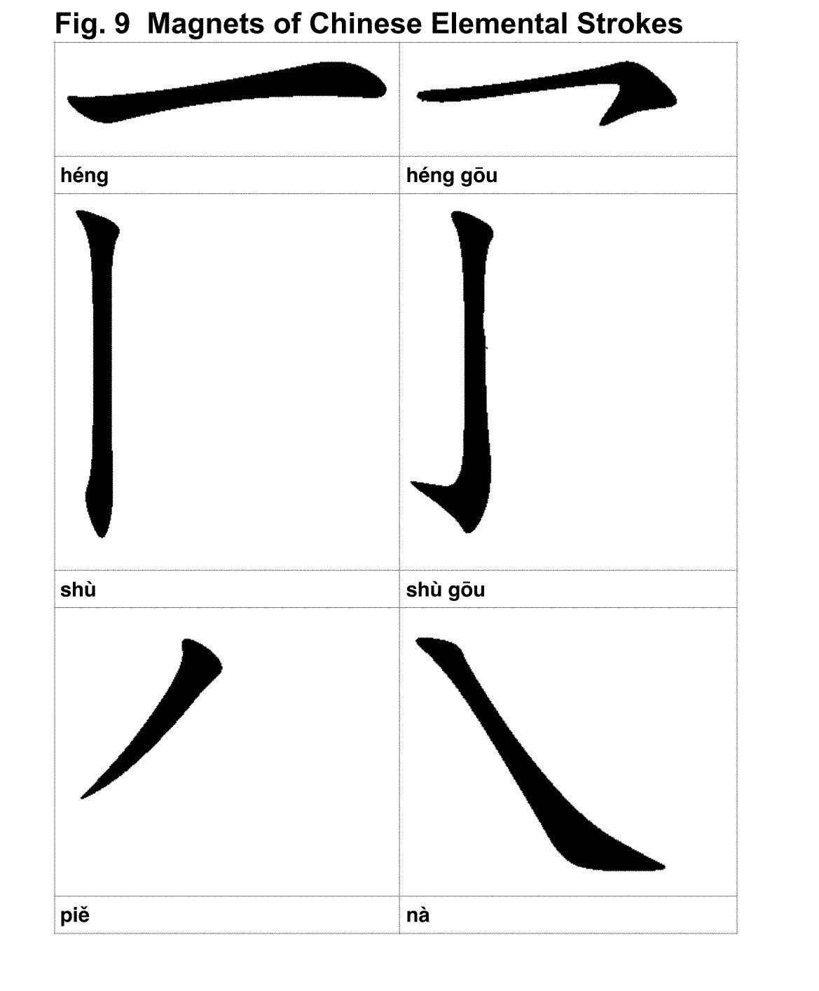

With reference to FIGS. 7 and 8, these strokes are expanded from the first Basic Chinese Strokes and the Developed Chinese Strokes which are a little complicated and use the same method as stated in EMBODIMENT 1, the length of time or period can be adjusted longer in line with baby's enthusiasm.

### Embodiment 4

With magnetic pieces, mommy and baby can play on the door of a refrigerator or a magnetic board. Taking “héng and shù” on the first cube of six basic Chinese strokes as examples, they can form many words with magnetic pieces of “héng and shù”, such as “ [symbol] one, [symbol] two, [symbol] three, [symbol] ten, [symbol] work, [symbol] up, [symbol] king, [symbol] soldier, [symbol] soil and [symbol] dry. Chinese characters are in sequences; however, before a child is three, stroke pieces are just for playing to stimulate the connections between brain and fingers, as well as to trigger baby's capability of creation. The child may place a word in the wrong order of strokes, but mommy or a caregiver can guide the baby to constitute a word in sequence according to the books associated with Chinese Stroke Toys.

I claim as my invention:

1. Five cubes, with each of its six sides bearing one of the 30 Chinese strokes, as follows: (1) Basic Strokes: héng, shù, di\check{a}n, piě, nà, tí; (2) Developed Strokes (A): héng gōu, shù gōu, héng piě, héng zhé, shù zhé, shù tí; (3) héng zhé gōu, héng zhé tí, piě zhé, shù wān, shù wān gōu, piě di\check{a}n; (4) xié gōu, wò gōu, wān gōu, héng xié gōu, héng zhé wān gōu, shù zhé zhé gōu; (5): héng piě wān gōu, héng piě wān gōu, héng zhé zhé zhé gōu, héng zhé wān, héng zhé zhé zhé piě, shù zhé piě and shù zhé zhé. For infants, cubes are made of soft materials, such as cloth; while for kids, age two and up, we use non-poison plastics, wood, and paper or other materials.

2. Magnetic Chinese strokes, of different sizes for different age groups, such that children can create their own Chinese characters; which they can proudly display on a magnetic board or the family refrigerator, thereby increasing their interest in learning Chinese characters.

3.
